(19) United States
(12) Patent Application Publication
(10) Pub. No.: US 2005/0018042 A1
(43) Pub. Date: Jan. 27, 2005

(54) Video processor for endoscopy

(76) Inventor: Jean Rovegno, La Ciotat (FR)

Correspondence Address: BACHMAN & LAPOINTE, P.C., 900 CHAPEL STREET, SUITE 1201, NEW HAVEN, CT, 06510, US

(21) Appl. No.: 10/879,569

(22) Filed: Jun. 28, 2004

(30) Foreign Application Priority Data
Jan. 7, 2003 (FR) 03 07950

(51) Int. Cl. H04N 7/18

(52) U.S. Cl. 348/65

(57) ABSTRACT

A video processor for endoscopic camera or for videoendoscopic probe associated with a color video sensor, the video processor comprising: a signal preprocessing circuit designed to be remotely connected to the video sensor through an electrical link without any intermediate connection device, the preprocessing circuit comprising a first signal processor for generating from image signals output by the video sensor raw video signals comprising a brightness signal and a color signal, these signals being not usable directly because they are phase shifted and are noisy due to synchronization residues, and a synchronizing circuit for synchronizing the video sensor and the first signal processor; and a remote auxiliary circuit comprising a second signal processor connected to the first signal processor through a low impedance electrical link providing good immunity to interference, the second signal processor generating from said raw video brightness and color signals at least one useful video signal according to an international video standard.

### BACKGROUND OF THE INVENTION

This invention relates to a video processor for a videoendoscopic probe or a video camera connectable to an endoscope.

It is particularly but not exclusively applicable to endoscopy for medical purposes and endoscopy for industrial purposes.

The terms endoscope or fiberscope refer to a flexible or rigid probe designed to be inserted into an obscure cavity so that its user can observe the image of a target located in the cavity through an ocular. For this purpose, the probe integrates a target illumination device and an optical device supplying an image of the target to the user. The optical device comprises a distal objective, an image transport device that is either inherently rigid composed of a series of lenses, or inherently flexible composed of a bundle of ordered optical fibers, and a proximal ocular in which the user can observe the image of the target. The illumination device generally comprises a bundle of illumination fibers for which the distal end, suitably arranged close to the distal objective, illuminates the target when its proximal end is connected to a light generator.

The term videoendoscope means a flexible or rigid probe that its user uses to observe the image of a target located in an obscure cavity on a video screen. This is achieved by the use of a videoendoscope comprising a target illumination device identical to that used in an endoscope or a fiberscope and an optoelectronic device providing the user with a video image of the target. A videoendoscope may be the result of the connection of the ocular of an endoscope or a fiberscope onto the objective of an endoscopy camera, or it may have a specific architecture characterizing a videoendoscopic probe and comprising:
a distal end piece housing an optoelectronic device particularly comprising a CCD sensor with a photosensitive surface on which the objective with which it is associated forms an image,
an inspection tube, usually a flexible tube, the distal end of which is fixed to the distal end piece,
a control handle fixed to the proximal end of the inspection tube,
a flexible connection umbilical tube, the distal end of which is fixed to the control handle and the proximal end of which will be connected to an external box particularly including a light generator and an electrical power supply source,
a bundle of illumination fibers housed in the umbilical tube, in the control handle, and then in the inspection tube, and the distal end of which housed in the distal end piece, illuminates the target when its proximal end is connected to a light generator,
a video processor transforming the electric signal output by the distal CCD sensor to which it is connected through a multiconductor electrical cable, and which is synchronized as a function of the length of the said cable and the structure of the CCD sensor interface microcircuit, into a useful video signal,
a control panel used particularly to set parameters for operation of the video processor as a function of the color temperature of the target illumination through the distal end of the fiber bundle illuminating the videoendoscopic probe, and
a video monitor connected to the video processor and preferably located in the immediate vicinity of the control handle.

Like fiberscopes, flexible videoendoscopic probes may also comprise an articulated distal tip deflection used to modify the orientation of the distal end piece of the probe, the control handle then including mechanical or electromechanical means that the user uses to activate the distal tip deflection.

An endoscope camera also comprises the following elements:
a camera head housing an optoelectronic device particularly comprising a CCD sensor with a photosensitive surface on which the image output by the adjustable focus objective with which it is associated is formed, and a locking device to fix the additional lens of an endoscope or a fiberscope onto the objective,
a flexible connection umbilical tube, the distal end of which is fixed to the camera head, and the proximal end of which is designed to be connected to an external box in which the video processor is generally housed,
a video processor transforming the electrical signal output by the CCD sensor of the camera head to which it is connected through a multiconductor electrical cable, and for which synchronization is adjusted as a function of the length of the said cable and the structure of the CCD sensor interface circuit, into a useful video signal,
a control panel used particularly to set parameters for operation of the video processor as a function of the color of the illumination of the target through the distal end of the fiber bundle illuminating the endoscope to which the camera head is connected, and
a video monitor connected to the video processor.

Regardless of whether it is integrated into a videoendoscopic probe or into an endoscopy camera, the video processor has a functional structure comprising:
signal processing means integrated into a more or less complex and therefore more or less voluminous circuit, denoted under the generic term of DSP (Digital Signal Processor) to which the electrical signal output by the CCD sensor is applied, and that outputs an analog or digital video signal depending on the type or methods of implementation of the said DSP,
synchronization means, integrated into or associated with the DSP, and acting simultaneously on the CCD sensor and signal processing means,
encoding and amplification means, integrated into or associated with the DSP, to transform the video signal output by the DSP into one or several analog video signals (composite, YC, RGB, etc) and/or digital video signals (USB, LLINK, VGA, ETHERNET, etc.),
logical control means for the DSP, composed of a microcontroller integrated into or associated with the DSP,
means for inputting commands managed by the user and usually consisting of a panel of touch sensitive keys directly associated with the microcontroller, and
power supply means generating electrical voltages necessary for operation of the CCD sensor and the video processor.

The joint operation of a color CCD sensor and the video processor with which it is associated is essentially the result of correct management of phase shifts of the different fast clocks generated by synchronization means of the video processor.

These fast clocks include firstly “pixel” synchronization signals that are transmitted to the distal CCD sensor that uses them firstly to synchronies reading of electrical voltages contained in unit cells (called pixels) on the photosensitive layer of the sensor, and secondly to extract significant information from these unit voltages that after integration form the electrical signal transmitted to the video processor. These fast clocks also include synchronization signals that are transmitted to the video processor that uses them to synchronies sampling of the electrical signal generated by the CCD sensor.

Correct operation of the processor necessarily requires that its sampling clock be perfectly in phase with the incident electrical signal from the CCD sensor. Transferring the color CCD sensor into the head of an endoscopic camera or the distal end of a videoendoscopic probe inevitably leads to an unacceptable phase shift at the processor between the sampling clock and the incident electrical signal, due to the length of the electrical links between the sensor and the video processor and characteristics of the interface circuit that may be associated with the sensor. This phase shift is the result of an accumulation of the transmission time of pixel synchronization signals generated by the video processor to the CCD sensor, the transmission time of the electrical signal generated by the CCD sensor to the video processor, and phase shifts introduced by the CCD sensor interface circuit. In general, to overcome such dysfunction, either the sampling clock is delayed or the pixel synchronization clock is delayed, so as to compensate for the global phase shift mentioned above. The methods of applying either of these delays and the resulting connection problems vary depending on the method of integration of the signal synchronization and processing means that, depending on the selected architecture, may be either external to the endoscopy camera or to the videoendoscopic probe, or may form an integral part of it.

Traditionally, the video processor of an endoscopy camera of a videoendoscopic probe is housed in an external box on which a multi-pin connector is connected to form the proximal end of the umbilical tube of the camera or the videoendoscopic probe. In this type of architecture, the control keys panel is usually integrated onto the front face of the external box, and the video monitor is directly connected to the box.

The considerations mentioned above show that connection of an endoscopy camera or a videoendoscopic probe to a video processor housed in an external box causes adaptation problems due to the need to compensate for synchronization delays induced by the probe or camera CCD sensor interface circuit, and by the electrical cable connecting the interface circuit to the video processor with which the CCD sensor is associated. If the external box is always associated with the same model of endoscopic camera, there is an inter-changeability problem imposing that the length of the umbilical cable of cameras shall always be exactly the same. For example, if the external box is associated with a range of videoendoscopic probes with different lengths (as described in U.S. Pat. No. 4,539,568), there will be a compatibility problem requiring the integration of a specific delay device into the connection box or into the control handle of the probe, acting on the fast clocks generated by the video processor and transmitted to the distal CCD sensor.

In any case, the use of an external video processor has another technical disadvantage concerning risks of interference of the electrical signal generated by the CCD sensor and transmitted to the video processor. Transport of the electrical signal generated by the CCD sensor is difficult due to its low intrinsic signal/noise ratio, and also due to its wide pass-band and its low power requiring a link with a high impedance that does not help to give good immunity to interference. The quality of such an electrical signal can also be reduced by aging or any other failure of contacts of the multi-pin connection system used to connect the proximal end of the umbilical tube of the camera or the probe to the external box housing the video processor.

One means of overcoming all or some of the disadvantages mentioned above would be to integrate the video processor as close as possible to the distal CCD sensor, in other words directly in the camera head in the case of an endoscopic camera, and in the control handle in the case of a videoendoscopic probe, and in the case of a videoendoscopic probe, to electrically connect the CCD sensor to the video processor through a link in which there is no risk of a break in the continuity. Unfortunately, the intrinsic size of a video processor is incompatible with the available volume in a camera head and in a small probe handle. The only known embodiments in this subject relate to the integration of a video processor either into a handle of an industrial videoendoscopic probe with an integrated video monitor (U.S. Pat. No. 6,315,712), or into a connection box fixed to the proximal end of the umbilical cable of an industrial probe (U.S. Pat. No. 5,702,345).

The purpose of this invention is to eliminate these disadvantages.

### SUMMARY OF THE INVENTION

This objective is achieved using a video processor for an endoscopic camera or for a videoendoscopic probe associated with a color video sensor, the video processor comprising:
a signal preprocessing circuit designed to be connected to the remote video sensor through an electrical link without any intermediate connection device, the preprocessing circuit comprising first signal processing means for generating from image signals output by the video sensor raw video signals comprising a brightness signal and a color signal, these signals being not directly usable because they are phase-shifted and noisy due to synchronization residues, and synchronization means for synchronizing the video sensor and the first signal processing means; and
a remote auxiliary circuit comprising second signal processing means connected to the first signal processing means through a low impedance electrical link providing good immunity to interference, the second signal processing means comprising means for generating from said raw video brightness and color signals at least one useful video signal according to an international standard.

According to one preferred embodiment of the invention, the raw video color and brightness signals are analog, the second signal processing means comprising a correction circuit for bringing into phase and filtering said raw video brightness and color signals and, and at least one encoding circuit for generating from the brought into phase and filtered raw video signals a useful analog or digital video signal according to an international standard.

According to another preferred embodiment of the invention, the raw video color and brightness signals are digital, the second signal processing means comprising at least one correction and encoding circuit for generating from said raw video brightness and color signals a useful analog or digital video signal according to an international standard.

Advantageously, the video sensor is a color CCD sensor of the line transfer type.

According to one preferred embodiment of the invention, the signal preprocessing circuit is fixed to the video sensor.

According to another preferred embodiment of the invention, the signal preprocessing circuit is connected through a multiconductor electrical cable to the video sensor that is remote from the preprocessing circuit, and comprises phase shifting means for delaying synchronization signals transmitted to the video sensor in order to compensate for transmission times introduced by the electrical cable.

According to one preferred embodiment of the invention, the signal preprocessing circuit is directly connected to the auxiliary circuit through a multiconductor electrical cable without any intermediate connection device.

According to another preferred embodiment of the invention, the signal preprocessing circuit is connected to the auxiliary circuit through an electrical link associated with an intermediate connection device.

According to one preferred embodiment of the invention, the auxiliary circuit comprises control means for setting parameters of the first signal processing means.

Advantageously, the control means are of the digital microcontroller type.

According to one preferred embodiment of the invention, the control means are connected to means for inputting operator commands comprising a control key to trigger parameter settings of the first signal processing means as a function of a color temperature of illumination picked up by the video sensor.

According to one preferred embodiment of the invention, the auxiliary card comprises a logical interface connecting the control means to a computer comprising a display screen on which the useful video signal can be displayed, and a keyboard for inputting parameter setting commands for the first signal processing means.

According to one preferred embodiment of the invention, the auxiliary circuit comprises an electrical power supply circuit for generating from a DC voltage voltages necessary to power supply the video sensor, the preprocessing circuit and the auxiliary circuit.

The invention also concerns a videoendoscopic probe comprising:
an inspection tube having a distal end which is fixed to a distal end piece,
a video sensor housed in the distal end piece,
a control handle fixed to the proximal end of the inspection tube,
an umbilical cable having a distal end which is fixed to the control handle,
a connection device fixed to the proximal end of the umbilical cable, and designed to be connected to a light generator, and
a bundle of illumination fibers housed in the umbilical cable, in the control handle and in the inspection tube, said bundle having a distal end housed in said distal end piece to illuminate a target when the proximal end of the bundle is connected to a light generator.

According to the invention, this probe comprises a video processor as defined above.

According to one preferred embodiment of the invention, the signal preprocessing circuit is:
housed in the control handle,
connected to the video sensor by a multiconductor electrical cable housed in the inspection tube, and
connected to the auxiliary circuit through a multiconductor electrical cable housed in the umbilical cable.

According to one preferred embodiment of the invention, the auxiliary circuit is housed in the connection device.

Alternatively, the auxiliary circuit is housed in an external box provided with a multi-pin connection socket to which the connection device can be connected.

According to one preferred embodiment of the invention, the connection device fixed to the proximal end of the umbilical cable is equipped with interchangeable fittings so that it can be connected to different types of light generators.

The invention also relates to an endoscopy camera comprising a camera head that can be connected to an eyepiece of an endoscope or fiberscope, said camera head comprising a video sensor, a multiconductor umbilical cable having a distal end which is fixed to the camera head, and a connection device fixed to the proximal end of the umbilical cable.

According to the invention, this camera comprises a video processor like that defined above.

According to one preferred embodiment of the invention:
the signal preprocessing circuit is housed in the camera head, and
the umbilical cable houses a multiconductor electrical cable connecting the preprocessing circuit to the auxiliary circuit.

According to one preferred embodiment of the invention, the auxiliary circuit is housed in an external box provided with means for connecting the connection device.

Alternatively, the auxiliary circuit may be housed in the connection device.

According to one preferred embodiment of the invention:
the signal preprocessing circuit is housed in the connection device connected to the camera head through the umbilical cable,
the auxiliary circuit is housed in an external box provided with a connection socket, and
the signal preprocessing circuit is connected to the video sensor through a multiconductor electrical cable housed in the umbilical cable, and connected to the auxiliary circuit through a multi-pin connector fixed to the connection device and designed to be connected to the connection socket.

### BRIEF DESCRIPTION OF THE DRAWINGS

One preferred embodiment of the invention will be described below, as a non-limitative example, with reference to the attached drawings in which:

FIG. 1 shows the functional structure of a video processor for endoscopy according to the invention;

FIG. 2 shows a variant of the functional structure of a video processor for endoscopy according to the invention, shown in FIG. 1;

FIG. 3 illustrates an example embodiment of the video processor shown in FIG. 1, in a videoendoscopic probe;

FIG. 4 illustrates an example embodiment of the video processor shown in FIG. 1, in an endoscopy camera;

FIG. 5 illustrates an example embodiment of the video processor shown in FIG. 2, in an endoscopy camera.

### DETAILED DESCRIPTION OF PREFERRED EMBODIMENTS

This invention is designed to integrate a video processor into a small videoendoscopic probe or endoscopy camera.

This objective is achieved by physically separating the signal processing functions themselves from the auxiliary functions of a video processor on two cards connected to each other through an electrical link. The card on which the signal processing functions are implanted is as small as possible so that it can fit into an endoscopy camera head or into the control handle of a videoendoscopic probe.

The first of these two cards is connected to the CCD sensor through an electrical link in which there is no risk of a break in the continuity. It is intended to be housed as close as possible to the CCD sensor and therefore preferably either in the handle of a videoendoscopic probe or in the head of an endoscopy camera. To achieve this, and in order to minimize its size, it only contains the minimum electronic means necessary to perform the following functions:
a processing function for processing the electrical signal output by the CCD sensor and generating a raw brightness signal (Y) and color signal (C) with sufficient power so that they can be transported by low impedance electrical links giving good immunity to interference,
a synchronization function for synchronizing the CCD sensor and the signal processing function, and
possibly a correction function for correcting synchronization of the remote CCD sensor as a function of the distance at which it is placed (if it is made remote) and the phase shifts introduced by its association with an interface circuit (if there is one).

The second of these two cards, preferably housed in a connection box rigidly fixed to the proximal end of the umbilical tube of a videoendoscopic probe or an endoscopy camera, supports electronic means for performing the following functions:
a logical driving function for driving the processing function of the first card,
a control function for controlling the driving function by keys preferably integrated on the connection box and/or through a logical link connected to external computer means,
a signal processing function for processing raw Y and C signals output by the first card and generating one or several useful analog and/or digital video signals, and
a power supply function for supplying the various DC electrical voltages necessary to operation of the two cards and the CDD sensor.

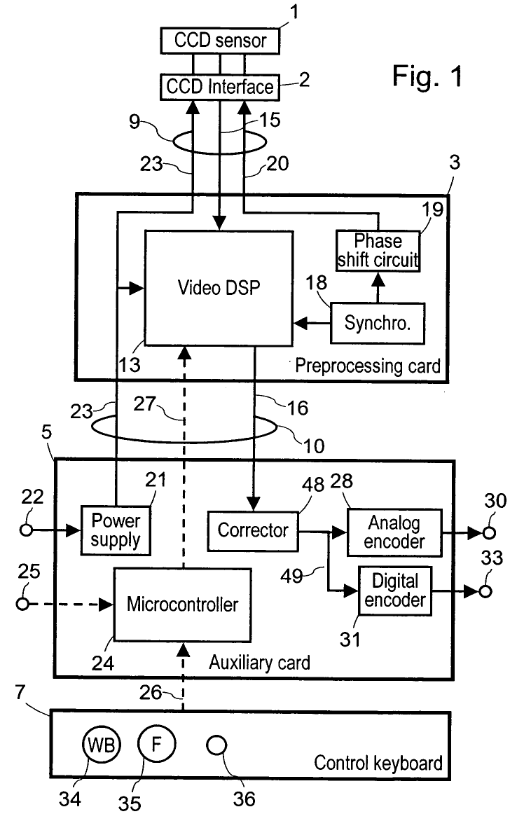

FIG. 1 shows the electronic architecture of a video processor for endoscopy according to the invention. This video processor is advantageously designed to be connected to a color type CCD sensor 1 of the line transfer type through an interface circuit 2.

In this Figure, the video processor comprises a preprocessing card 3 connected to the CCD sensor 1 through the interface circuit 2 and an auxiliary card 5 connected to the preprocessing card 3. The interface circuit 2 is designed to shape the synchronization signals transmitted by the preprocessing card through an electrical link 20 and improve the impedance matching of the electrical signal output by the CCD sensor, the resulting signal being transmitted to the preprocessing card through a high impedance electrical link 15.

The preprocessing card 3 supports a synchronization clock generator 18 and a video digital signal processor 13 synchronized by the generator 18. The digital processor receives the electrical signal generated by the color CCD sensor 1 through the electrical link 15, and adapted by the interface circuit 2, and outputs on a link 16 a raw analog video signal not directly displayable on a video screen but that is sufficiently powerful so that it can be transmitted through a low impedance link and consequently with good immunity to interference.

The signal processing processor 13 is advantageously composed of a video DSP (Digital Signal Processor) controlled by a serial digital signal, for example of the TTL type output from the auxiliary card through a link 27. The generator 18 also synchronizes the CCD sensor 1 through a link 20. The processor 13 is preferably a non-programmable DSP for which parameters can be set easily, dedicated to the selected video sensor so as to have a minimum size so that it can for example easily be integrated in the handle of a videoendoscopic probe.

The preprocessing card 3 is connected to the auxiliary card 5 through a multiconductor cable 10 comprising electrical power supply links 23 for the card 3 and the CCD sensor 1, the control link 27 of the DSP processor 13 and the raw analog video signal transmission link 16 output by the DSP processor 13.

The auxiliary card 5 supports an electrical power supply device 21, a processor 24, for example of the microcontroller type, an analog correction circuit 48 and encoders 28, 31 outputting useful video signals 30, 33 respectively, in other words according to an international standard that can be displayed directly on a video screen. The power supply device 21 that is designed to be connected to an external electrical power source 22, generates different DC power supply voltages necessary for operation of the cards 3, 5 and the color CCD sensor 1. The microcontroller 24, controlled through a connection 25, for example an RS232 type link, and through a link 26, for example of the TTL type, originating from a control keyboard 7, preferably with touch sensitive keys, outputs serial digital signals through the link 27 used to control the DSP processor 13.

The connection 25 will be connected to a computer (not shown), the keyboard of which can be used to input commands, and the display screen to display the useful digital video signal 33.

The correction circuit 48 receives the raw analog video signal output by the DSP processor 13 through the link 16, and it uses this signal to generate a useful video signal that is transmitted to the encoders 28, 31 forming the video output interface of the DSP processor 13, through the link 49.

The raw analog video signals output by the DSP processor 13 comprises a brightness signal Y and a color signal C, these signal being said to be raw because they are not in phase and are noisy particularly as a result of synchronization clock residues (not filtered), but have sufficient power so that they can be transmitted through a low impedance link which consequently have good immunity to interference.

The analog correction circuit 48 performs a pass-band type filtering and it puts the Y and C signals of the raw analog video signals into phase and transmits the resulting useful video signal through the link 49 to the encoding devices 28, 31.

The analog encoding device 28 outputs a useful analog video signal 30 of the composite video type, while the digital encoding device 31 outputs a useful digital video signal 33, for example of the USB2 type, the video signals 30, 33 being displayed directly on a video screen.

The control keyboard 7 with touch sensitive keys is a simplified compact keyboard comprising a key 34 used to automatically set operating parameters for the DSP processor 13 as a function of the color temperature of the light through the distal end of the videoendoscopic probe or the endoscope associated with an endoscopy camera, a key 35 for activating a parameter setting function of the DSP processor 13, this function being preprogrammed in the microcontroller 24, and a diode 36 signaling activation of this function.

In this way, the videoendoscopic probe or the video endoscopy camera in which the video processor according to the invention is integrated is automatically adapted to the color temperature of the light generator to which the illumination fiber bundle of the videoendoscopic probe or the endoscope is connected, and therefore eventually to the light generator, depending on the type of illumination lamp (halogen, mercury vapor, xenon, etc.). Therefore, the videoendoscopic probe or the video endoscopy camera may be associated with any light generator.

The optional use of a PC type portable computer with a USB2 type input connected to the output 33 of the auxiliary card 5 of the video processor and an RS 232 port connected to the input 25 of the microcontroller 24 of the auxiliary card, enable the user to use the video processor directly from the computer means and benefit from all parameter and parameter setting features of the video DSP 13.

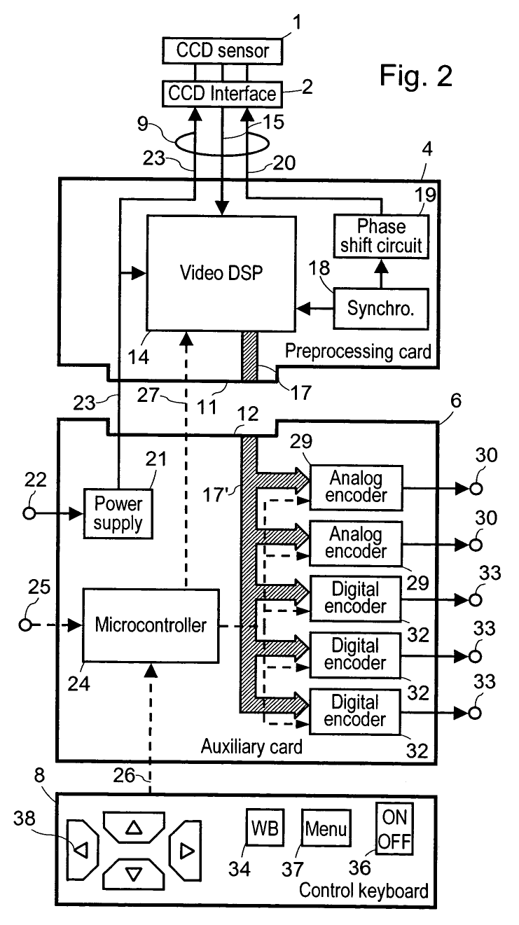

FIG. 2 illustrates a variant according to the invention of the video processor shown in FIG. 1. In this Figure, the color CCD sensor 1 associated with the interface circuit 2 is coupled to a video processor for which the elements are distributed on a preprocessing card 4 and an auxiliary card 6. The interface circuit 2 is connected to the preprocessing card 4 through a multiconductor cable 9 comprising electrical power supply links 23 for the CCD sensor, synchronization links 20 of the CCD sensor, and the transmission link 15 for the signals output by the CCD sensor.

The preprocessing card 4 supports a synchronization clock generator 18, a phase shifting circuit 19 and a video digital signal processor (DSP) 14 controlled by a serial digital signal, and directly synchronized by the clock generator 18. The video DSP processor 14 receives the electrical signals output by the CCD sensor 1 and generates a raw digital video signal transmitted to the auxiliary card 6 through a link 17. The “pixel” synchronization clocks of the CCD sensor are output by the clock generator 18 and are then delayed by the phase shifting circuit 19 before being transmitted through the electrical link 20 to the CCD sensor, so as to compensate for propagation delays introduced by the electrical links 15 and 20, and phase shifts introduced by the interface circuit 2.

The processor 14 is also preferably a non-programmable DSP for which parameters can be easily set, dedicated to the selected video sensor, so as to have a minimum size and so that it can for example be easily integrated into the handle of a videoendoscopic probe.

The auxiliary card 6 supports the electrical power supply device 21, the microcontroller 24 and several encoders 29, 32, receiving the raw digital video signal through the link 17 and outputting the useful video signals 30, 33 respectively. The power supply device 21 connected to a source of external electrical energy 22, generates the different DC power supply voltages necessary for operation of the cards 4, 6 and the color CCD sensor 1. The microcontroller 24 controlled through a connection 25 and through the link 26 from a control touch sensitive keyboard 8, outputs serial digital signals used to control the DSP processor 14, through the link 27. For example, the connection 25 is an RS 232 type link and links 26 and 27 are TTL type links.

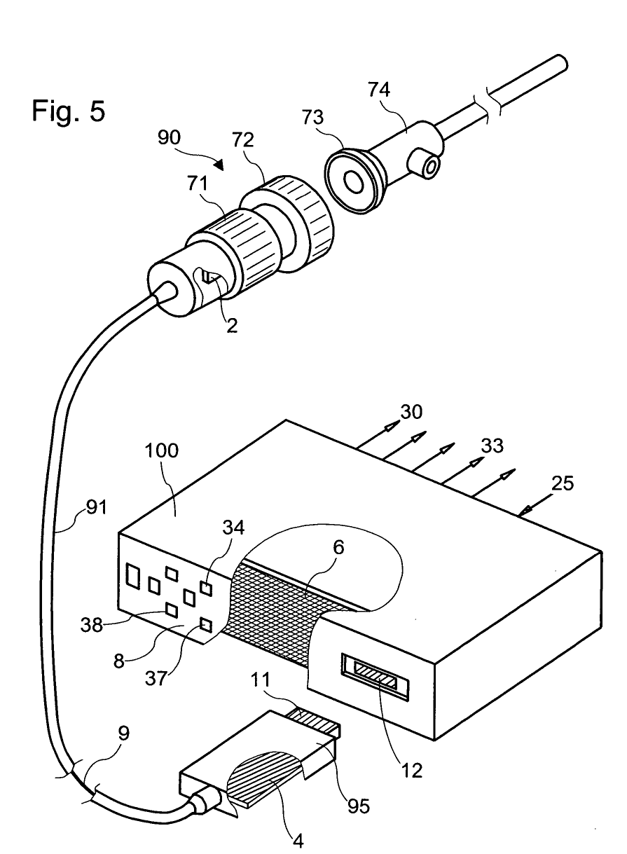

Due to its intrinsic size, the auxiliary card 6 is housed in an external box. And due to the intrinsic complexity of its output interface, the preprocessing card 4 is housed in a connection box fixed to the proximal end of an umbilical cable 9 (FIG. 5) directly connected to the external box through a connection device 11, 12.

The digital video signals output by the DSP processor 14 on the link 17 preferably comprises two digital signals each with eight bits corresponding to the raw color C and brightness Y components of the video signals, these signals being said to be raw because they are not in phase and they are noisy, particularly due to residues from the synchronization clock. Depending on the type of DSP processor, the link 17 transmitting the Y and C digital signals is composed of either a 16-bit bus or an 8-bit bus in which the Y and C signals are multiplexed.

The encoders 29 and 32 comprise one or several digital/analog encoders that output useful analog video signals 30, for example of the composite, YC and RGB type, and one or several digital/digital encoders 32 that output useful digital video signals 33, for example of the USB2 and VGA type.

The encoders 29 and 32 are made with commercially available components integrating anti-aliasing filtering functions and for bringing into phase necessary for corrections to the raw YC type digital video signal produced by the DSP processor 14.

The control keyboard 8 with touch sensitive keys comprises a key 34 that automatically sets operating parameters of the DSP processor 14 as a function of the color temperature of the light output by the distal end of the videoendoscopic probe or the endoscope associated with the endoscopy camera, a key 37 used to enter the settings menu of the DSP processor 14, and four navigation keys 38 used to select and adjust the various functions in the menu.

The optional use of a PC type portable computer provided with a USB2 input connected to the USB2 type output 33 of the auxiliary card 6 and an RS 232 port connected to the connection 25 of the microcontroller 24, enables the user to use the video processor according to the invention, directly from computer means.

Architectures according to the invention illustrated in FIGS. 1 and 2 minimize the number and size of components to be placed as close as possible to the video sensor (on the preprocessing card), the functions necessary to generate a useful video signal that are not done by the preprocessing card being remote on the auxiliary card.

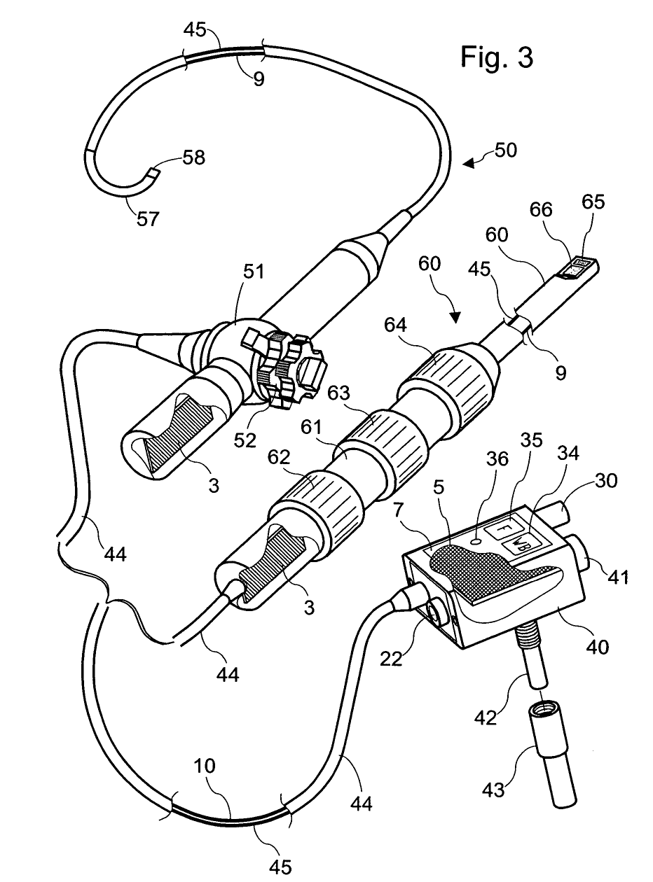

FIG. 3 illustrates the architecture of a flexible videoendoscopic probe 50 and a rigid videoendoscopic probe 60, using the video processor described above with reference to FIG. 1.

In these architectures, the preprocessing card 3 is housed in the proximal ends of the control handles 51 and 61 of the probes 50 and 60, these handles being fixed to the distal end of an umbilical cable 44, the proximal end of which is fixed to a connection box 40 housing the auxiliary card 5 and supporting the simplified control keyboard 7.

The flexible videoendoscopic probe 50 comprises the following elements:
a distal end piece 58 fixed to a tip deflection 57 and in which an objective is housed, the CCD sensor 1, the interface circuit 2, and the distal end of a bundle of illumination fibers 45;
a flexible inspection tube, the distal end of which is fixed to the tip deflection 57 that houses the tip deflection control cables, the illumination fiber bundle 45 and the multiconductor cable 9 electrically connecting the interface circuit 2 of the CCD sensor 1 to the preprocessing card 3;
a control handle 51 fixed to the proximal end of the flexible inspection tube and the distal end of the umbilical cable 44, the handle housing the preprocessing card 3 and supporting actuation means 52 enabling the user to act on the tip deflection control cables 57; and
the umbilical cable 44 containing the illumination fiber bundle 45 and the multiconductor cable 10 electrically connecting the preprocessing card 3 to the auxiliary card 5.

The rigid videoendoscopic probe 60 is a deviated sighting probe advantageously containing controls for rotation of the line of sight, variation of the angle of sight, and focus settings. This videoendoscopic probe that uses mechanical control devices identical to devices integrated into multi-function endoscopes described in U.S. patent application Ser. No. 2003/097,044 deposited by the Applicant, is the result of the functional association of the elements described below.

A distal end in which there are a lateral viewing window 66 and a lateral illumination window 65 are placed housing the distal end of the illumination fiber bundle 45, and housing an optoelectronic device comprising a distal deviator prism, an objective and the CDD sensor 1 associated with its interface circuit 2.

A rigid inspection tube housing a focusing control tube for which the distal end is fixed to the CCD sensor, the multiconductor cable 9 housed in the focusing control tube and electrically connecting the interface circuit 2 of the CCD sensor 1 to the preprocessing card 3, a sighting control tube housed free to slide around the focusing control tube and the distal end of which controls the tilting of the distal deviator prism, and a bundle of illumination fibers 45 for which the fibers are distributed in the annular space between the sighting control tube and the external tube of the probe 60.

A control handle 61 fixed to the distal end of the umbilical cable 44, housing the preprocessing card 3 and supporting a distal ring 64 fixed to the proximal end of the rigid inspection tube used to control rotation of the tube about its axis, a central ring 63 used to control translation displacements of the sighting control tube and therefore tilting of the distal deviator prism, and a proximal ring 62 used to control translation displacements of the focusing control tube and therefore translation displacements of the CCD sensor.

An umbilical cable 44 housing the illumination fiber bundle 45 and the multiconductor cable 10 electrically connecting the preprocessing card 3 to the auxiliary card 5.

The connection box 40 fixed to the proximal end of the umbilical cable 44 is provided with an illumination end piece 42 housing the proximal end of the illumination fiber bundle 45 and is capable of receiving different types of mechanical adaptors 43 for connecting the box 40 to different types of light generators. The connection box 40 houses the auxiliary card 5 that is thus associated with the simplified control keyboard 7, in accordance with the description of FIG. 1 given above. The connection box 40 also comprises:
a power supply connection socket 22 that will be connected to an external source of electrical energy, preferably an independent generator outputting a standard DC electrical voltage, for example 12 volts,
a video connection socket 30 that will be connected to a video monitor and outputting an analog video signal preferably of the composite type, and
a computer type multi-pin connection socket 41 that will be connected either to a dedicated digital image processing system, or to a PC type standard computer, this socket containing an RS232 connection associated with either an analog video connection, for example of the composite type, or a digital video connection, for example of the USB2 type.

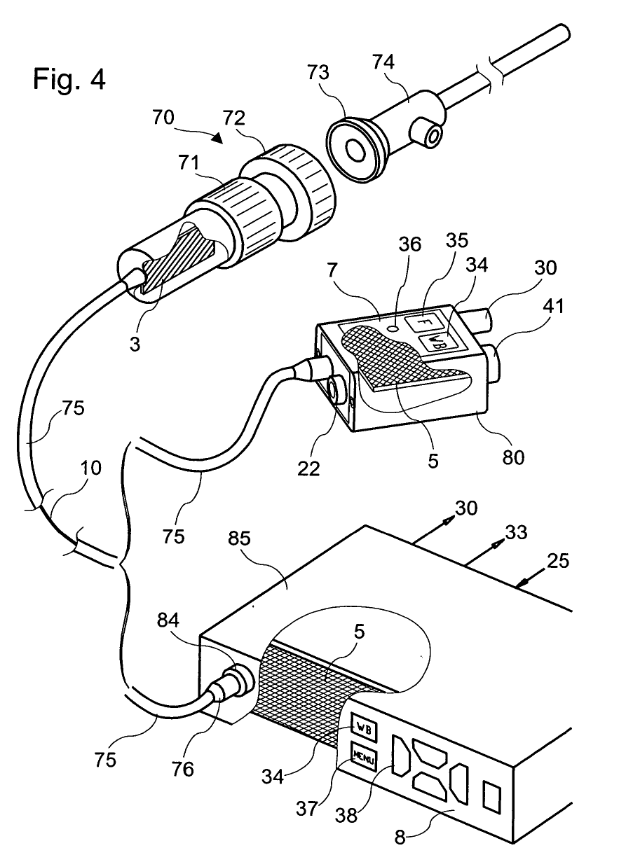

FIG. 4 illustrates the architectures of two endoscopy cameras 70, 80 and 70, 85, using the video processor described above with reference to FIG. 1, and associating the preprocessing card 3 and the auxiliary card 5. In these architectures, the preprocessing card 3 is housed in a camera head 70 fixed to the distal end of an umbilical cable 75, the proximal end of which is either fixed to a connection box 80 housing the auxiliary card 5 and supporting the simplified control keyboard 7, or can be connected to an external box 85 housing the auxiliary card 5 and supporting the control keyboard 8 described above with reference to FIG. 2.

The camera head 70 is the result of a functional association of the following elements:
an objective, which is focused by rotating an external setting ring 71,
a device 72 fixed to the distal part of the objective and used to mechanically lock the camera head onto the proximal additional lens 73 of an endoscope 74,
the CCD sensor 1 on the photosensitive surface of which the image output by the objective is formed,
the preprocessing card 3 directly associated with the CCD sensor, and
an umbilical cable 75 housing the multiconductor cable 10 electrically connecting the preprocessing card 3 to the auxiliary card 5.

The connection box 80 fixed to the proximal end of the umbilical cable 75 houses the auxiliary card 5 which is associated with a simplified control keyboard 7 provided with two touch sensitive keys 34, 35 and the light 36, in accordance with the text in FIG. 1. The connection box is provided with an interface comprising connection sockets 22, 30 and 41 described above with reference to FIG. 3.

The box 85 is provided with a connection socket 84 electrically fixed to the auxiliary card 5 housed in the said box, this socket being designed to be connected to the connector 76 fixed to the proximal end of the umbilical cable 75 and transmitting electrical signals transported through the multiconductor cable 10 housed in the umbilical cable 75 and providing the link between the preprocessing card 3 and the auxiliary card 5. The auxiliary card 5 is associated with the control keyboard 8 described above with reference to FIG. 2.

Note that the probes 50, 60 shown in FIG. 3 may alternatively be connected to a box such as the box 85 described with reference to FIG. 4, to replace the connection box 40.

FIG. 5 illustrates the architecture of an endoscopy camera 90 using the video processor described above with reference to FIG. 2, associating the preprocessing card 4 and the auxiliary card 6. The preprocessing card 4 is housed in a connection box 95 fixed to the proximal end of an umbilical cable 91 of the camera head 90 and that can be connected to an external box 100 housing the auxiliary card 6 and supporting the control keyboard 8.

The camera head 90 is the result of the functional association of the following elements:
an objective, for which the focusing is controlled by rotation of an external setting ring 71,
a mechanical device 72 fixed to the distal part of the objective and used to lock the camera head onto the proximal additional lens 73 of an endoscope 74,
the CCD sensor 1 on the photosensitive surface of which the image output by the objective is formed,
the interface circuit 2 directly associated with the CCD sensor, and
the umbilical cable 91 housing the multiconductor cable 9 electrically connecting the interface circuit 2 of the CCD sensor to the preprocessing card 4.

The connection box 95 is provided with a multi-pin connector 11 electrically fixed to the preprocessing card 4 housed in the box 95, while the box 100 is provided with the multi-pin connection socket 12 electrically fixed to the auxiliary card 6 housed in the said box, this socket being designed to contain the connector 11 of the connection box 95. In accordance with the above description of FIG. 2, the auxiliary card 6 is associated with the control keyboard 8. The box 100 also is provided with connection sockets distributing one or several analog video signals 30, one or several digital video signals 33 and an RS 232 type control channel 25.

Note that the architecture illustrated in FIG. 5 may also be adapted to the videoendoscopic probes shown in FIG. 3.

1. A video processor for endoscopic camera or for videoendoscopic probe associated with a color video sensor, the video processor comprising:
a signal preprocessing circuit designed to be remotely connected to the video sensor through an electrical link without any intermediate connection device, the preprocessing circuit comprising first signal processing means for generating from image signals output by the video sensor raw video signals comprising a brightness signal and a color signal, these signals being not usable directly because they are phase shifted and are noisy due to synchronization residues, and means for synchronizing the video sensor and the first signal processing means; and
a remote auxiliary circuit comprising second signal processing means connected to the first signal processing means through a low impedance electrical link providing good immunity to interference, the second signal processing means comprising means for generating from said raw video brightness and color signals at least one useful video signal according to an international standard.

2. The video processor according to claim 1, wherein said raw color and brightness video signals are analog, said second signal processing means comprising a correction circuit for bringing into phase and filtering said raw video brightness and color signals, and at least one encoding circuit for generating from the brought into phase and filtered raw video signals a useful analog or digital video signal according to an international standard.

3. The video processor according to claim 1, wherein said raw color and brightness video signals are digital, said second signal processing means comprising at least one correction and encoding circuit for generating from said raw brightness and color video signals a useful analog or digital video signal according to an international standard.

4. The video processor according to claim 1, wherein said video sensor is a color CCD sensor of the line transfer type.

5. The video processor according to claim 1, wherein said signal preprocessing circuit is integral with the video sensor.

6. The video processor according to claim 1, wherein said signal preprocessing circuit is connected through a multiconductor electrical cable to the video sensor that is remote from the preprocessing circuit and comprises phase shifting means for delaying synchronization signals transmitted to the video sensor, to compensate for transmission times induced by the multiconductor electrical cable.

7. The video processor according to claim 1, wherein said signal preprocessing circuit is directly connected to the auxiliary circuit through a multiconductor electrical cable, without any intermediate connection device.

8. The video processor according to claim 1, wherein said signal preprocessing circuit is connected to the auxiliary circuit through an electrical link associated with an intermediate connection device.

9. The video processor according to claim 1, wherein said auxiliary circuit comprises driving means for setting parameters of said first signal processing means.

10. The video processor according to claim 9, wherein said driving means are of digital microcontroller type.

11. The video processor according to claim 9, wherein said driving means are connected to operator inputting means comprising a command key for controlling setting parameters of said first signal processing means as a function of an illumination color temperature picked up by the video sensor.

12. The video processor according to claim 9, wherein said auxiliary card comprises a logical interface for connecting said driving means to a computer comprising a display screen on which the useful video signal can be displayed, and a keyboard for inputting parameter setting commands for said first signal processing means.

13. The video processor according to claim 1, wherein said auxiliary circuit comprises an electrical power supply circuit for generating from a DC voltage voltages for power supplying the video sensor, the preprocessing circuit and the auxiliary circuit.

14. A videoendoscopic probe comprising:
an inspection tube having a distal end which is fixed to a distal end piece,
a video sensor housed in the distal end piece,
a control handle fixed to the proximal end of said inspection tube,
an umbilical cable having a distal end which is fixed to the control handle,
a connection device fixed to the proximal end of the umbilical cable, and designed to be connected to a light generator, and
a bundle of illumination fibers housed in the umbilical cable, in the control handle and in the inspection tube, the distal end of the bundle being housed in the distal end to illuminate a target when the proximal end of the bundle is connected to a light generator,
a signal preprocessing circuit designed to be remotely connected to the video sensor through an electrical link without any intermediate connection device, the preprocessing circuit comprising first signal processing means for generating from image signals output by the video sensor raw video signals comprising a brightness signal and a color signal, these signals being not usable directly because they are phase shifted and are noisy due to synchronization residues, and means for synchronizing the video sensor and the first signal processing means; and
a remote auxiliary circuit comprising second signal processing means connected to the first signal processing means through a low impedance electrical link providing good immunity to interference, the second signal processing means comprising means for generating from said raw video brightness and color signals at least one useful video signal according to an international standard.

15. The videoendoscopic probe according to claim 14, wherein the signal preprocessing circuit is:
housed in the control handle,
connected to the video sensor through a multiconductor electrical cable housed in the inspection tube, and
connected to the auxiliary circuit through a multiconductor electrical cable housed in the umbilical cable.

16. The videoendoscopic probe according to claim 15, wherein the auxiliary circuit is housed in the connection device.

17. The videoendoscopic probe according to claim 15, wherein the auxiliary circuit is housed in an external box provided with a multi-pin connection socket to which the connection device can be connected.

18. The videoendoscopic probe according to claim 14, wherein the connection device fixed to the proximal end of the umbilical cable, is provided with interchangeable fittings so that it can be connected to different types of light generators.

19. An endoscopy camera comprising a camera head connectable on an eye piece of an endoscope or a fiberscope, said camera head comprising
a video sensor,
a multiconductor umbilical cable having a distal end which is fixed to said camera head,
a connection device fixed to the proximal end of the umbilical cable,
a signal preprocessing circuit designed to be remotely connected to the video sensor through an electrical link without any intermediate connection device, the preprocessing circuit comprising first signal processing means for generating from image signals output by the video sensor raw video signals comprising a brightness signal and a color signal, these signals being not usable directly because they are phase shifted and are noisy due to synchronization residues, and means for synchronizing the video sensor and the first signal processing means; and
a remote auxiliary circuit comprising second signal processing means connected to the first signal processing means through a low impedance electrical link providing good immunity to interference, the second signal processing means comprising means for generating from said raw video brightness and color signals at least one useful video signal according to an international standard.

20. The endoscopy camera according to claim 19, wherein:
said signal preprocessing circuit is housed in the camera head, and
said umbilical cable houses a multiconductor electrical cable connecting the preprocessing circuit to the auxiliary circuit.

21. The endoscopy camera according to claim 20, wherein said auxiliary circuit is housed in an external box provided with connection means of said connection device.

22. The endoscopy camera according to claim 20, wherein said auxiliary circuit is housed in said connection device.

23. The endoscopy camera according to claim 19, wherein:
said signal preprocessing circuit is housed in said connection device connected to the camera head through the umbilical cable,
said auxiliary circuit is housed in an external box provided with a connection socket, and
said signal preprocessing circuit is connected to the video sensor by a multiconductor electrical cable housed in the umbilical cable, and connected to the auxiliary circuit by a multi-pin connector fixed to the connection device and designed to be connected to the connection socket.
